(19) United States
(12) Patent Application Publication
(10) Pub. No.: US 2023/0137337 A1
(43) Pub. Date: May 4, 2023

(54) ENHANCED MACHINE LEARNING MODEL FOR JOINT DETECTION AND MULTI PERSON POSE ESTIMATION

(71) Applicant: TEXAS INSTRUMENTS INCORPORATED, Dallas, TX (US)

(72) Inventors: Debapriya MAJI, Asansol (IN); Soyeb NAGORI, Bengaluru (IN); Manu MATHEW, Bengaluru (IN); Deepak Kumar PODDAR, Bengaluru (IN)

(21) Appl. No.: 17/851,651

(22) Filed: Jun. 28, 2022

(30) Foreign Application Priority Data
Oct. 28, 2021 (IN) 202141049432

(51) Int. Cl. G06V 10/25; G06V 10/44; G06V 10/74

(52) U.S. Cl. CPC G06V 10/25; G06V 10/443; G06V 10/761

(57) ABSTRACT

A technique for key-point detection, including receiving, by a machine learning model, an input image, generating a set of image features for the input image, determining, by the machine learning model, based on the set of image features, a bounding box for an object detected in the input image, the bounding box described by bounding box information, identifying, by the machine learning model, based on the set of image features and a center point of the bounding box, a plurality of key-points associated with the object, filtering the plurality of key-points based on a confidence score associated with each key-point of the plurality of key-points, and outputting coordinates of the plurality of key-points, confidence scores associated with the plurality of key-points, and the bounding box information.

### CROSS-REFERENCE TO RELATED APPLICATIONS

This application claims priority to India Provisional Application No. 202141049432, filed Oct. 28, 2021, which is hereby incorporated by reference.

### BACKGROUND

Machine learning (ML) is becoming an increasingly important part of the computing landscape. Machine learning may be implemented via ML models. Machine learning is a branch of artificial intelligence (AI), and ML models help enable a software system to learn to recognize patterns from data without being directly programmed to do so. Neural networks (NN) are a type of ML model that utilize a set of linked and layered functions to evaluate input data. In some NNs, sometimes referred to as convolution NNs (CNNs), convolution operations are performed in NN layers based on inputs received and weights. Machine learning models are often used in a wide array of applications, such as image classification, object detection, prediction and recommendation systems, speech recognition, language translation, sensing, etc.

### SUMMARY

This disclosure relates to a method for key-point detection. The method includes receiving, by a machine learning model, an input image. The method further includes generating a set of image features for the input image. The method also includes determining, by the machine learning model based on the set of image features, a bounding box for an object detected in the input image, the bounding box described by bounding box information. The method further includes identifying, by the machine learning model, based on the set of image features and a center point of the bounding box, a plurality of key-points associated with the object. The method also includes filtering the plurality of key-points based on a confidence score associated with each key-point of the plurality of key-points. The method further includes outputting coordinates of the plurality of key-points, confidence scores associated with the plurality of key-points, and the bounding box information.

Another aspect of this disclosure relates to a machine learning system for key-point detection. The machine learning system includes a first stage configured to generate a set of image features for an input image. The machine learning system further includes a second stage configured to aggregate the set of image features. The machine learning system also includes a third stage. The third stage includes a bounding box detection head for determining, based on the set of image features, a bounding box for an object detected in the input image, the bounding box described by bounding box information. The third stage also includes a key-point detection head. The key-point detection head is for identifying, based on the set of image features and a center point of the bounding box, a plurality of key-points associated with the object. The key-point detection head is also for filtering the plurality of key-points based on a confidence score associated with each key-point of the plurality of key-points. The key-point detection head is further for outputting coordinates of the plurality of key-points, confidence scores associated with the plurality of key-points, and the bounding box information.

Another aspect of this disclosure relates to a non-transitory program storage device including instructions stored thereon to cause one or more processors to receive, by a machine learning model executing on the one or more processors, an input image. The instructions further cause the one or more processors to generate a set of image features for the input image. The instructions also cause the one or more processors to determine, by the machine learning model, based on the set of image features, a bounding box for an object detected in the input image, the bounding box described by bounding box information. The instructions further cause the one or more processors to identify, by the machine learning model, based on the set of image features and a center point of the bounding box, a plurality of key-points associated with the object. The instructions also cause the one or more processors to filter the plurality of key-points based on a confidence score associated with each key-point of the plurality of key-points. The instructions further cause the one or more processors to output coordinates of the plurality of key-points, confidence scores associated with the plurality of key-points, and the bounding box information.

### BRIEF DESCRIPTION OF THE DRAWINGS

For a detailed description of various examples, reference will now be made to the accompanying drawings in which:

FIG. 1A illustrates an example NN ML model, in accordance with aspects of the present disclosure.

FIG. 1B illustrates an example structure of a layer of the NN ML model, in accordance with aspects of the present disclosure.

FIG. 2 is an architectural diagram of an object detection ML network, in accordance with aspects of the present disclosure.

FIG. 3 is an architectural diagram of an enhanced object detection ML network configured to perform pose estimation, in accordance with aspects of the present disclosure.

FIG. 4 is a flow diagram illustrating a technique for detecting key-points for pose estimation, in accordance with aspects of the present disclosure.

FIG. 5 is a block diagram of an example a computing device, in accordance with aspects of the present disclosure.

The same reference numbers or other reference designators are used in the drawings to designate the same or similar (either by function and/or structure) features.

### DETAILED DESCRIPTION

Increasingly, ML models are being used for pose estimation, which is a computer vision technique that allows joints for a detected object to be identified. This pose information is based on a set of key-points identified for the detected object. These key-points may generally represent joints or other movement points of the detected object. In existing pose estimation systems, separate ML models are used for object detection and pose estimation (e.g., key point detection), or pose estimation is performed independent of object detection. These existing systems can have varying execution times, rely on varying post-processing techniques, or may be complex to execute. Techniques for increasing the performance of pose estimation may be useful.

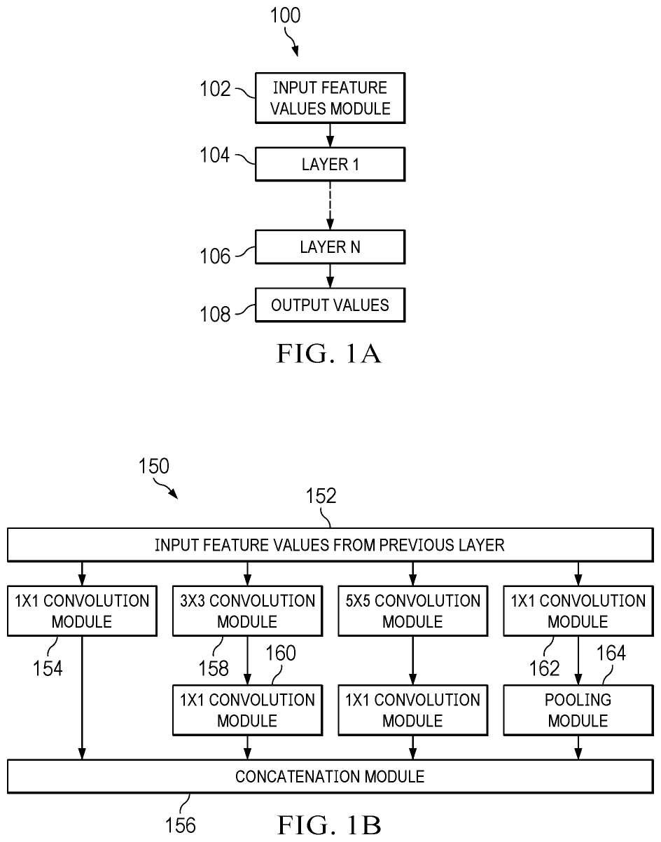

FIG. 1A illustrates an example NN ML model 100, in accordance with aspects of the present disclosure. The example NN ML model 100 is a simplified example presented to help understand how an NN ML model 100, such as a CNN, is structured. Examples of NN ML models may include VGG, MobileNet, ResNet, EfficientNet, RegNet, etc. It may be understood that each implementation of an ML model may execute one or more ML algorithms, and the ML model may be trained or tuned in a different way depending on a variety of factors, including, but not limited to, a type of ML model being used, parameters being used for the ML model, relationships among the parameters, desired speed of training, etc. In this simplified example, feature values are collected and prepared in an input feature values module 102. As an example, an image may be input into an ML model by placing the color values of the pixels of the image together in, for example, a vector or matrix, as the input feature values by the input feature values module 102. Generally, parameters may refer to aspects of mathematical functions that may be applied by layers of the NN ML model 100 to features, which are the data points or variables.

Each layer (e.g., first layer 104 . . . Nth layer 106) may include a plurality of modules (e.g., nodes) and generally represents a set of operations that may be performed on the feature values, such as a set of matrix multiplications, convolutions, deconvolutions, etc. For example, each layer may include one or more mathematical functions that takes as input (aside from the first layer 104) the output feature values from a previous layer. The ML model outputs output values 108 from the last layer (e.g., the Nth layer 106). Weights that are input to the modules of each layer may be adjusted during ML model training and fixed after the ML model training. The ML model may include any number of layers. Generally, each layer transforms M number of input features to N number of output features.

In some cases, the ML model may be trained based on labelled input. For example, ML model 100 may be initiated with initial weights and the representative input passed into the ML model 100 to generate predictions. The representative inputs, such as images, may include labels that identify the data to be predicted. For example, where an ML model is being trained to detect and identify objects in an image, the image may include, for example, as metadata a label indicating locations of objects (such as for a bounding box around the objects) in the image, along with an indication of what the object is. The weights of the nodes may be adjusted based on how accurate the prediction is as compared to the labels. The weights applied by a node may be adjusted during training based on a loss function, which is a function that describes how accurately the predictions of the neural network are as compared to the expected results (e.g., labels); an optimization algorithm, which helps determine weight settings adjustments based on the loss function; and/or a backpropagation of error algorithm, which applies the weight adjustments back through the layers of the neural network. Any optimization algorithm (e.g., gradient descent, mini-batch gradient descent, stochastic gradient descent, adaptive optimizers, momentum, etc.), loss function (e.g., mean-squared error, cross-entropy, maximum likelihood, etc.), and backpropagation of error algorithm (e.g., static or recurrent backpropagation) may be used within the scope of this disclosure.

FIG. 1B illustrates an example structure of a layer 150 of the NN ML model 100, in accordance with aspects of the present disclosure. In some cases, one or more portions of the input feature values from a previous layer 152 (or input feature values from an input feature values module 102 for a first layer 104) may be input into a set of modules. Generally, modules of the set of modules may represent one or more sets of mathematical operations to be performed on the feature values, and each module may accept, as input, a set of weights, scale values, and/or biases. For example, a first 1×1 convolution module 154 may perform a 1×1 convolution operation on one or more portions of the input feature values and a set of weights (and/or bias/scale values). Of note, sets of modules of the one or more sets of modules may include different numbers of modules. Thus, output from the first 1×1 convolution module 154 may be input to a concatenation module 156. As another example, one or more portions of the input feature values from a previous layer 152 may also be input to a 3×3 convolution module 158, which outputs to a second 1×1 convolution module 160, which then outputs to the concatenation module 156. Sets of modules of the one or more sets of modules may also perform different operations. In this example, output from third 1×1 convolution module 162 may be input to a pooling module 164 for a pooling operation. Output from the pooling module 164 may be input to the concatenation module 156. The concatenation module 156 may receive outputs from each set of modules of the one or more sets of modules and concatenate the outputs together as output feature values. These output feature values may be input to a next layer of the NN ML model 100.

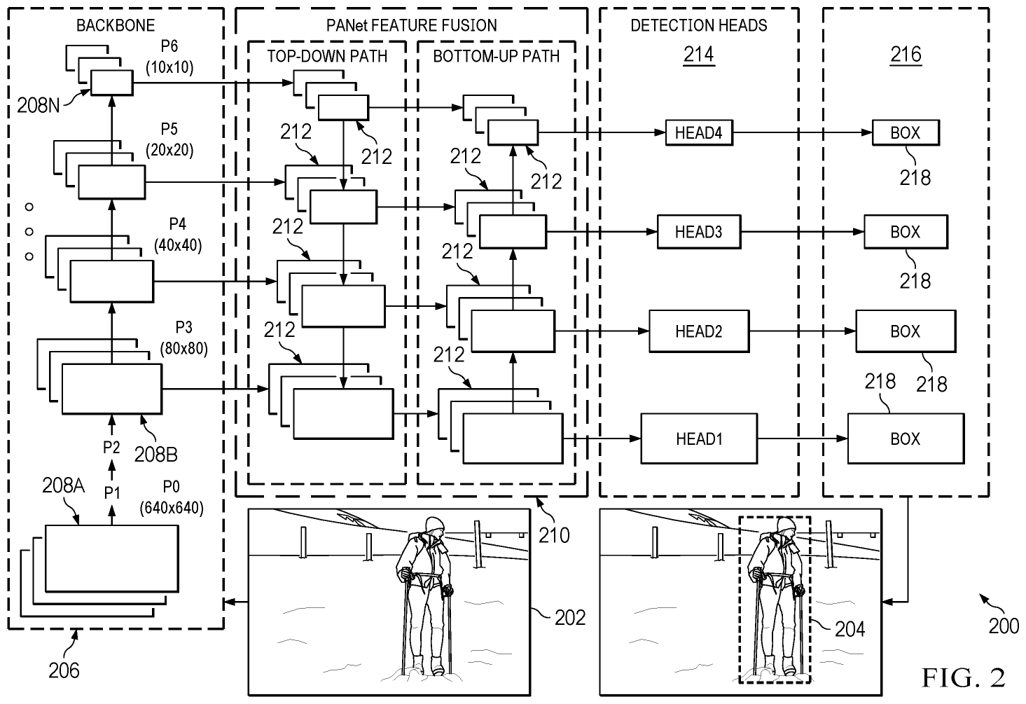

FIG. 2 is an architectural diagram of an object detection ML network 200, in accordance with aspects of the present disclosure. The object detection ML network 200 in this example diagrams an architecture of a you only look once (“YOLO”) object detection ML model. As shown, an image 202 may be input into the object detection ML network 200. The object detection ML network then detects objects in the image 202 and outputs one or more vectors containing coordinates for a bounding box 204 which highlight object(s) detected in the image along with an indication of the object detected in the bound box 204, here, a person. In some cases, the output may also include a confidence score indicating how confident the object detection ML network 200 is that a corresponding bounding box 204 contains the predicted object.

As shown, the object detection ML network 200 includes multiple stages and each stage performs a certain functionality. Each stage in turn contains multiple layers. In this example, the object detection ML network 200 includes three primary stages and an output stage. The first stage 206, also sometimes referred to as a backbone stage, includes sets of layers 208A, 2086, . . . 208N) which extracts image features at different resolutions (e.g., scales). The image features can include a variety of aspects of the image, such as shapes, edges, repeating textures, etc. These image features may be passed to a second stage 210, also sometimes referred to as a neck stage. The second stage 210 in this example also includes sets of layers 212 and may be based on a path aggregation network (PANet). The second stage 210 mixes and aggregates the image features at the different resolutions. Output from the second stage 210 is then passed into a third stage 214, also sometimes referred to as a head stage. This third stage 214 consumes the mixed features from the neck stage and predicts bounding boxes at the different resolutions. The third stage 214 outputs these predicted bounding boxes information to an output stage 216, which merges the bounding box information 218 across the different resolutions and outputs a vector containing coordinates for the bounding box 204, an indication of the object detected in the bound box 204, and, in some cases, a confidence score. For example, for each detected object, a vector of {Cₓ, C_{y}, W, H, box_{conf}} may be output where Cₓ and C_{y are X, Y coordinates of a center of a bounding box, W and H are width and height, respectively, of the bounding box, and box}_{conf} is the confidence score.

In contrast to object detection, pose estimation is a computer vision technique that predicts body joints (e.g., key-points) for a detected person in an image. Pose estimation is useful for predicting a spatial position or tracking a detected person across images. Existing pose estimation techniques typically can be grouped into two categories. The first category includes top-down approaches, which first use object detectors to detect persons in the image and then apply pose estimation for each detected person. These top-down approaches can be difficult to apply in real-time applications as complexity generally increases linearly with the number of people in the image, resulting in variable execution times. The second category includes bottom-up approaches, which first attempts to detect key-points for persons and then applies post processing to group the detected key-points into persons. While bottom-up approaches can result in consistent execution times, the post-processing applied can be complex and difficult to accelerate in hardware. In accordance with aspects of the present disclosure, object detection ML models, such as object detection ML network 200, may be enhanced to perform pose estimation along with detecting and identifying objects in an image.

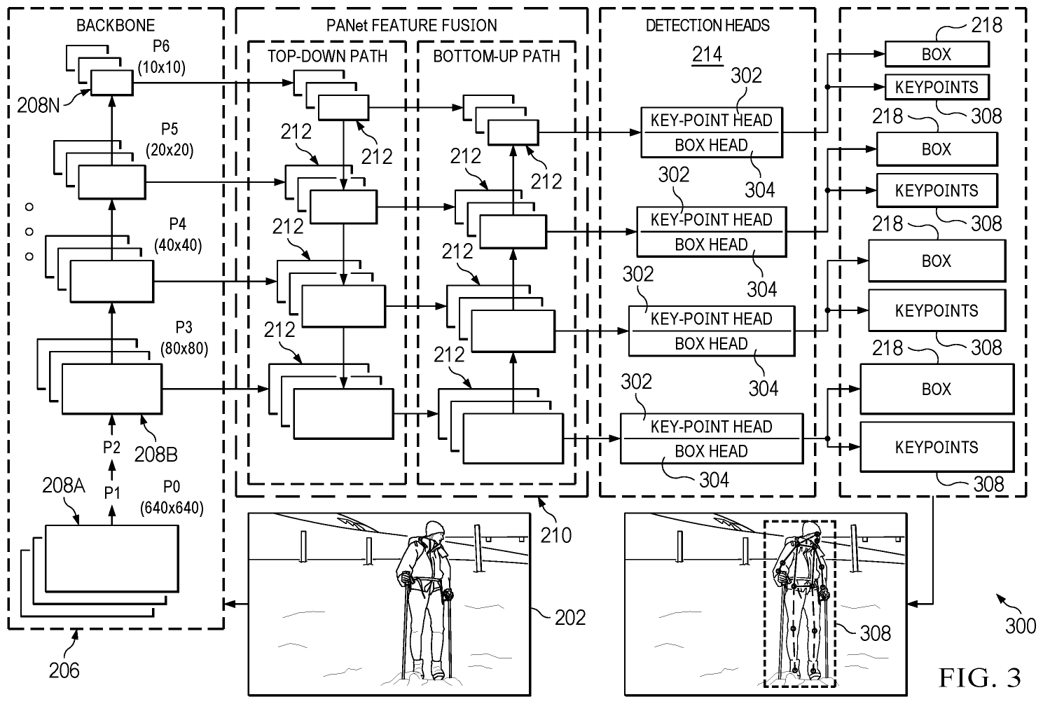

FIG. 3 is an architectural diagram of an enhanced object detection ML network 300 configured to perform pose estimation, in accordance with aspects of the present disclosure. The enhanced object detection ML network 300 enhances object detection ML network 200 by adding key-point detection heads 302 in addition to existing bounding box detection heads 304 in the third stage 214. The key-point detection heads 302 are added with the bounding box detection heads 304 at the different resolutions. The key-point detection heads 302 predict a set of key-points 308 for detected persons in addition to the bounding box information 218. The number of key-points predicted per detected person may be fixed in some cases. For each key-point, a confidence value is also generated. The predicted key-points information may be combined with the object detection, such that the output vector includes the bounding box information (e.g., coordinates, objected detected, confidence) and the predicted key-points. For example, for each detected object, a vector of {Cₓ, C_{y}, W, H, box_{conf}, Kₓ¹, K_{y}¹, K_{conf}¹, . . . , Kₓⁿ, K_{y}ⁿ, K_{conf}ⁿ} may be output, where Kₓ and K_{y} represent X, Y coordinates of a key-point with n number of key-points, and K_{conf} as the confidence score. Modifying an object detection ML network to perform pose estimation can take advantage of the existing feature detectors of the object detection ML network and allows for lower complexity as compared to multi-stage object detection and pose estimation approaches. Additionally, by integrating pose detection into the head stage of the object detection ML network, pose detection can be performed with consistent run times and minimal additional processing above the object detection ML network.

The key-point detection heads 302 may detect key-points based on image feature information along with information from the bounding box detection heads 304. As indicated above, the bounding box detection heads 304 may be a set of ML layers trained to detect and identify an object and identify a bounding box around the identified object. This information may be leveraged for key-point detection for those objects that key-points are to be identified for. For example, key-points may be determined for objects identified as a person, but key-points may not be identified for objects identified as a tree or bush. The bounding box information may also be leveraged for key-point detection.

The key-point detection heads 302 may comprise a relatively small set of layers that are trained to detect key-points based on the image features described by the feature information from the second stage 210 and bounding box information, such as the center of the bounding box. For example, the key-point detection heads 302 may include a single or a small set of convolutional layers that learn to recognize key-points based on a combination of image features and how far those features are from the center of the bounding box. The key-point detection heads 302 output an n number of predicted key-points. For example, the key-point detection heads 302 may output a specified number of key-points for each detected object.

Each predicted key-point includes a confidence score indicating how confident the key-point detection head 302 is of the prediction. In some cases, the confidence score for the key-points may be a sigmoid function applied to the confidence score that is predicted by the key-point detection head 302 along with each key-point location. The confidence score may be used to remove certain predicted key-points. For example, as key-points outside a field of view (e.g., boundaries) of an image may be predicted based on, for example, the location of the center of the bounding box and image features that are visible in the field of the view of the image, the confidence score for key-points that lie outside of the boundaries of the image may be predicted to be zero (e.g., less than a threshold value) and discarded. Key-points with a confidence less than a threshold value may be discarded. In some cases, the threshold value may be 0.5. Key-points with a confidence score higher than the threshold may be retained. In some cases, less than n number of predicted key-points may be predicted, for example, where certain key-points do not meet the threshold value.

As the key-points are predicted based on a bounding box, there is no need to group key-points, for example, in a separate, post-processing process. Additionally, while key-points are predicted based on the bounding box, key-points are filtered based on the confidence score associated with the predicted key-point rather than the borders of the bounding box. Thus, predicted key-points may lie outside of the bounding box. Additionally, as the key-points are predicted based on the bounding box and not how the bounding box is identified, this technique can be applied across a variety of object detection ML networks, including those with bounding box anchors and anchor-free implementations.

In some cases, as the key-points are predicted based on a segment of the image, as directly output by the key-point detection head 302 may be predicted as offsets with regards to the bounding box center. These offset key-points may be decoded using a linear transformation. For example, the key-point detection head 302 may output encoded offset X and Y values for a key-point, and this offset value may be decoded using a set of linear equations. These encoded offset X and Y values may be relative to a segment of the image used for object detection, such as an anchor center or grid center. A key-point location value relative to a segment of the image used for object detection (as opposed to the bounding box center) on the x-axis (kₓ) may be determined as kₓ=(X+Cₓ−0.5)*S, where Cₓ is the location of the segment of the image used for object detection on the x-axis relative to the image and S is a scale at which the prediction is being made at. Similarly, key-point location value relative to the image on the y-axis (k_{y}) may be determined as k_{y}=(Y+C_{y}−0.5)*S, where C_{y} is the location of the center of the segment of the image used for object detection on the y-axis relative to the image and S is a scale at which the prediction is being made at. The confidence score of the key-point (kconf) may be determined as k_{conf}=sigmoid(predicted score), where sigmoid is the sigmoid function and predicted score is a predicted confidence score.

Training of the key-point detection heads 302 may extend the intersection over union (IOU) training technique that can be used when training bounding box detection. As an example, an IOU may be determined for a predicted bounding box based on a ground truth for a correct bounding box provided by labels for the training set and a prediction for the bounding box by the ML network in training. The IOU may then be calculated for the area common to both the correct bounding box and the predicted bounding box and dividing this by the total area covered by the two bounding boxes. For improving quality of the predicted key-points, an object key-point similarity (OKS) metric may be used as a loss function in place of conventional Li loss functions for training key-point detection. The loss function describes how much the predicted results differ from the expected results as defined in the labels of the training set. For example, the loss function for evaluating key-point predictions ( [symbol] ₖₚₜₛ) may be expressed as [symbol] ₖₚₜₛ=1−Σₙ₌₁^{N}^{ₖₚₜₛ}OKS, where Nₖₚₜₛ represents the number of key-points. The OKS may be expressed as

$$\frac{exp ( \frac{{d}_{n}^{2}}{2 {s}^{2} {k}_{n}^{2}} ) δ ( {v}_{n} > 0 )}{δ ( {v}_{n} > 0 )} ,$$

where dₙ represents an Euclidian distance between the predicted key-point and a ground truth location for the nth key-point, where kₙ represents a weight of the nth key-point, where S represents the scale of the object, and where δ(vₙ) represents a visibility flag for the nth key-point. In some cases, the visibility flag indicates whether the key-point is within the field of view. The visibility flag may be set to zero if the key-point is not within the field of view. If the key-point is within the field of view, but is occluded, the visibility flag may still be set as if the key-point is visible. In some cases, the visibility flag may be primarily used for training, for example, the confidence score of the key-points, and key-points of training images may be labeled with visibility information. As OKS includes the scale of the object, OKS loss is scale-invariant and inherently produces different weights for different key-points.

In addition to key-point position, the confidence score predicted by the key-point detection heads 302 may also be trained using a loss function. This key-point confidence loss ( [symbol] _{kpts_conf}) may be the binary cross-entropy (BCE) loss between the predicted confidence and the ground-truth visibility flag. This key-point confidence loss function may be expressed as [symbol] _{kpts_conf}=Σₙ₌₁^{N}^{ₖₚₜₛ}BCE (δ(vₙ>0), pₖₚₜₛⁿ), where δ(vₙ) represents a visibility flag for the nth key-point and where pₖₚₜₛⁿ represents the predicted confidence for the nth key-point.

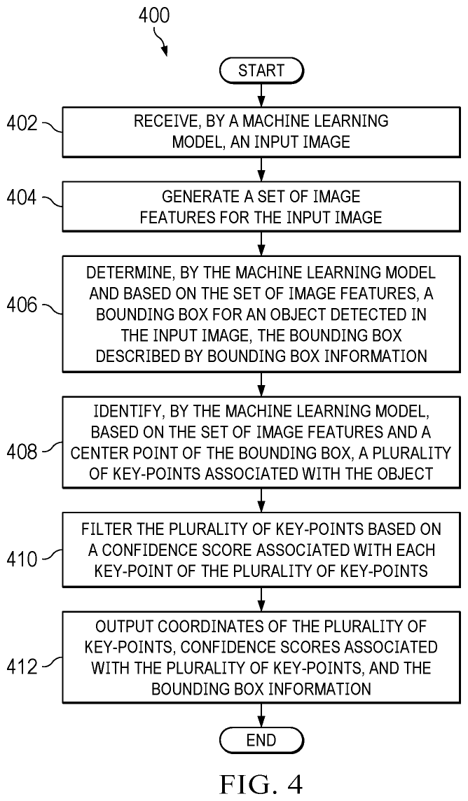

FIG. 4 is a flow diagram 400 illustrating a technique for detecting key-points for pose estimation, in accordance with aspects of the present disclosure. At block 402, a machine learning model receives an input image. For example, during inference (e.g., operation of a trained ML network) an enhanced object detection ML network may receive an image. In some cases, the enhanced object detection ML network may be based on an object detection ML network to predict key-points along with detecting and identifying objects. Examples of an object detection ML network include YOLO, YOLOX, etc. In some cases, the object detection ML network may include multiple stages, which perform certain functionality, such as feature extraction by a first stage, feature mixing and/or aggregation in a second stage, and prediction in a third stage. Each stage may contain one or more layers of the ML network.

In some cases, the enhanced object detection ML network may be trained to identify coordinates of key-points based on an object key-point similarity loss function. In some cases, the enhanced object detection ML network may be trained to identify the confidence score of key-points based on a binary cross-entropy loss.

At block 404, the ML model generates a set of image features for the input image. For example, features may be extracted from the image and aggregated, mixed, or otherwise processed. Object detection for images may be performed based on the set of image features. At block 406, the machine learning model determines, based on the set of image features, a bounding box for an object detected in the input image, and the bounding box described by bounding box information. For example, the ML model performs object detection to identify bounding boxes for objects detected in the image. The ML model may then identify the objects detected based, for example, on the bounding boxes and the set of image features. The bounding box may be described, for example, by the ML model using X and Y coordinates relative to the input image and a center of the bounding box, along with width and height information for the bounding box. In some cases, the bounding box may be determined (e.g., predicted) in the third stage of the ML network, for example, by a bounding box detection head.

At block 408, the ML model identifies, based on the set of image features and a center point of the bounding box, a plurality of key-points associated with the object. For example, the ML model may include a key-point detection head with ML layers trained to identify key-points in an image. The key-points may be identified relative to a segment of the image used for object detection. In some cases, the key-points, including key-point coordinates and confidence scores, may be encoded relative to a segment of the image used for object detection. The encoded key-points may be linearly transformed to decode the key-point information for the plurality of key points. In some cases, separate linear transformations may be applied to values on the X axis, Y axis, and confidence score.

At block 410, the ML network filters the plurality of key-points based on a confidence score associated with each key-point of the plurality of key-points. The predicted key-points may be filtered based on a threshold confidence score to generate the set of key-points for output. For example, predicted key-points with a confidence score below the threshold confidence score may be dropped. In some cases, a determination is made that a predicted key-point is outside of the field of view of the input image. In such cases, the predicted confidence score associated with the predicted key-point may be below the threshold confidence score. For example, the predicted confidence score associated with the predicted key-point that is outside of the field of view of the image may be zero. In one example, the threshold confidence score may be 0.5. At block 412, the ML network outputs coordinates of the plurality of key-points, confidence scores associated with the plurality of key-points, and the bounding box information.

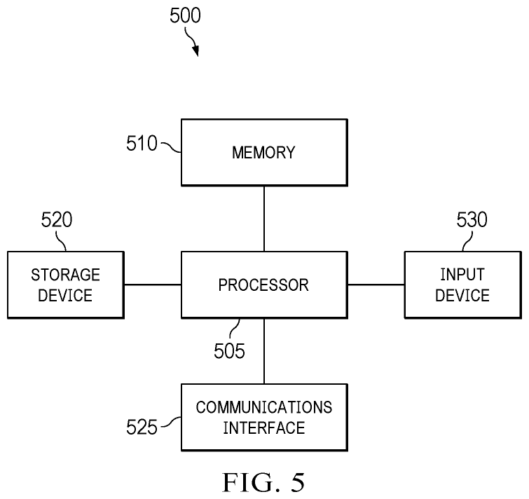

As illustrated in FIG. 5, device 500 includes processing circuitry, such as processor 505 that contains one or more hardware processors, where each hardware processor may have a single or multiple processor cores. Examples of processors include, but are not limited to, a central processing unit (CPU), image processor, microcontroller (MCU) microprocessor (MPU), digital signal processor (DSP), a field-programmable gate array (FPGA), an application-specific integrated circuit (ASIC), etc. Although not illustrated in FIG. 5, the processing circuitry that makes up processor 505 may also include one or more other types of hardware processing components, such as graphics processing units (GPUs), application specific integrated circuits (ASICs), field-programmable gate arrays (FPGAs), and/or digital signal processors (DSPs). In certain cases, processor 505 may be configured to perform the tasks described in conjunction with the technique described in FIG. 4. In some cases, the processor 505 may be configured to train the ML model as described in FIGS. 2 and 3.

FIG. 5 illustrates that memory 510 may be operatively and communicatively coupled to processor 505. Memory 510 may be a non-transitory computer readable storage medium configured to store various types of data. For example, memory 510 may include one or more volatile devices, such as random-access memory (RAM), registers, etc. Non-volatile storage devices 520 can include one or more disk drives, optical drives, solid-state drives (SSDs), tap drives, flash memory, electrically erasable programmable read-only memory (EEPROM), and/or any other type memory designed to maintain data for a duration of time after a power loss or shut down operation. The non-volatile storage devices 520 may also be used to store programs that are loaded into the RAM when such programs are executed. In some cases, programs stored in the non-volatile storage device 520 may be executed directly from the non-volatile storage device 520.

Persons of ordinary skill in the art are aware that software programs may be developed, encoded, and compiled in a variety of computing languages for a variety of software platforms and/or operating systems and subsequently loaded and executed by processor 505. In one embodiment, the compiling process of the software program may transform program code written in a programming language to another computer language such that the processor 505 is able to execute the programming code. For example, the compiling process of the software program may generate an executable program that provides encoded instructions (e.g., machine code instructions) for processor 505 to accomplish specific, non-generic, particular computing functions.

After the compiling process, the encoded instructions may then be loaded as computer executable instructions or process steps to processor 505 from storage device 520, from memory 510, and/or embedded within processor 505 (e.g., via a cache or on-board ROM). Processor 505 may be configured to execute the stored instructions or process steps in order to perform instructions or process steps to transform the computing device into a non-generic, particular, specially programmed machine or apparatus. Stored data, e.g. data stored by a storage device 520, may be accessed by processor 505 during the execution of computer executable instructions or process steps to instruct one or more components within the computing device 500. Storage device 520 may be partitioned or split into multiple sections that may be accessed by different software programs. For example, storage device 520 may include a section designated for specific purposes, such as storing program instructions or data for updating software of the computing device 500. In one embodiment, the software to be updated includes the ROM, or firmware, of the computing device. In certain cases, the computing device 500 may include multiple operating systems. For example, the computing device 500 may include a general-purpose operating system that is utilized for normal operations. The computing device 500 may also include another operating system, such as a bootloader, for performing specific tasks, such as upgrading and recovering the general-purpose operating system and allowing access to the computing device 500 at a level generally not available through the general-purpose operating system. Both the general-purpose operating system and another operating system may have access to the section of storage device 520 designated for specific purposes.

The one or more communications interfaces 525 may include a radio communications interface for interfacing with one or more radio communications devices, such as an AP (not shown in FIG. 5). In some cases, the communications interfaces 525 may include the communications module 304 as described in FIG. 3. In certain cases, elements coupled to the processor may be included on hardware shared with the processor. For example, the communications interfaces 525, storage device 520, and memory 510 may be included along with other elements, such as the digital radio, in a single chip or package, such as in a system on a chip (SOC). Computing device 500 may also include input and/or output devices not shown, examples of which include sensors, cameras, human input devices, such as mouse, keyboard, touchscreen, monitors, display screen, tactile or motion generators, speakers, lights, etc. Processed input, for example from the image sensor, may be output from the computing device 500 via the communications interfaces 525 to one or more other devices.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

While certain elements of the described examples are included in an integrated circuit and other elements are external to the integrated circuit, in other example embodiments additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated circuit. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Modifications are possible to the described embodiments, and other embodiments are possible, within the scope of the claims.

What is claimed is:

1. A method for key-point detection, comprising:
receiving, by a machine learning model, an input image;
generating a set of image features for the input image;
determining, by the machine learning model, based on the set of image features, a bounding box for an object detected in the input image, the bounding box described by bounding box information;
identifying, by the machine learning model, based on the set of image features and a center point of the bounding box, a plurality of key-points associated with the object;
filtering the plurality of key-points based on a confidence score associated with each key-point of the plurality of key-points; and
outputting coordinates of the plurality of key-points, confidence scores associated with the plurality of key-points, and the bounding box information.

2. The method of claim 1, wherein identifying the plurality of key-points includes:
receiving encoded key-point information;
linearly transforming the encoded key-point information for the plurality of key-points.

3. The method of claim 2, wherein the encoded key-point information includes a predicted key-point confidence score, and further comprises transforming the predicted key-point confidence score based on a sigmoid function for the plurality of key-points.

4. The method of claim 1, wherein filtering the plurality of key-points is further based on a threshold confidence score to generate a set of key-points.

5. The method of claim 1, further comprising:
determining that a key-point, of the plurality of key-points, is outside of a field of view of the input image; and
setting a visibility flag of the key-point based on the determination that the key-point is outside the field of view.

6. The method of claim 1, wherein the machine learning model is trained to identify coordinates of key-points based on an object key-point similarly loss function.

7. The method of claim 1, wherein the machine learning model is trained to identify the confidence score of key-points based on a binary cross-entropy loss.

8. A machine learning system for key-point detection, comprising:
a first stage configured to generate a set of image features for an input image;
a second stage configured to aggregate the set of image features; and
a third stage including:
a bounding box detection head for determining, based on the set of image features, a bounding box for an object detected in the input image, the bounding box described by bounding box information; and
a key-point detection head for:
identifying, based on the set of image features and a center point of the bounding box, a plurality of key-points associated with the object;
filtering the plurality of key-points based on a confidence score associated with each key-point of the plurality of key-points; and
outputting coordinates of the plurality of key-points, confidence scores associated with the plurality of key-points, and the bounding box information.

9. The system of claim 8, wherein the key-point detection head identifies the plurality of key-points by:
receiving encoded key-point information;
linearly transforming the encoded key-point information for the plurality of key-points.

10. The system of claim 9, wherein the encoded key-point information includes a predicted key-point confidence score and wherein the key-point detection head transforms the predicted key-point confidence score based on a sigmoid function for the plurality of key-points.

11. The system of claim 8, wherein filtering the plurality of key-points is further based on a threshold confidence score to generate a set of key-points.

12. The system of claim 8, wherein the key-point detection head filters the plurality of key-points by:
determining that a key-point, of the plurality of key-points, is outside of a field of view of the input image; and
setting a visibility flag of the key-point based on the determination that the key-point is outside the field of view.

13. The system of claim 8, wherein the system is trained to identify coordinates of key-points based on an object key-point similarity loss function.

14. The system of claim 8, wherein the system is trained to identify the confidence scores of key-points based on a binary cross-entropy loss.

15. A non-transitory program storage device comprising instructions stored thereon to cause one or more processors to:
receive, by a machine learning model executing on the one or more processors, an input image;
generate a set of image features for the input image;
determine, by the machine learning model, based on the set of image features, a bounding box for an object detected in the input image and the bounding box described by bounding box information;
identify, by the machine learning model, based on the set of image features and a center point of the bounding box, a plurality of key-points associated with the object;
filter the plurality of key-points based on a confidence score associated with each key-point of the plurality of key-points; and
output coordinates of the plurality of key-points, confidence scores associated with the plurality of key-points, and the bounding box information.

16. The non-transitory program storage device of claim 15, wherein identifying the plurality of key-points includes:
receiving encoded key-point information;
linearly transforming the encoded key-point information for the plurality of key-points.

17. The non-transitory program storage device of claim 16, wherein the encoded key-point information includes a predicted key-point confidence score and wherein the instructions further cause the one or more processors to transform the predicted key-point confidence score based on a sigmoid function for the plurality of key-points.

18. The non-transitory program storage device of claim 15, wherein filtering the plurality of key-points is further based on a threshold confidence score to generate a set of key-points.

19. The non-transitory program storage device of claim 15, wherein the instructions further cause the one or more processors to:
determine that a key-point, of the plurality of key-points, is outside of a field of view of the input image; and
set a visibility flag of the key-point based on the determination that the key-point is outside the field of view.

20. The non-transitory program storage device of claim 15, wherein the machine learning model is trained to identify coordinates of key-points based on an object key-point similarity loss function.
